(19) United States
(12) Patent Application Publication
(10) Pub. No.: US 2021/0280890 A1
(43) Pub. Date: Sep. 9, 2021

(54) REDOX FLOW BATTERY

(71) Applicant: Panasonic Intellectual Property Management Co., Ltd., Osaka (JP)

(72) Inventors: MASAHISA FUJIMOTO, Osaka (JP); SHUJI ITO, Nara (JP); YU OTSUKA, Osaka (JP); YUKA OKADA, Hyogo (JP)

(21) Appl. No.: 17/327,853

(22) Filed: May 24, 2021

Related U.S. Application Data
(63) Continuation of application No. PCT/JP2019/026874, filed on Jul. 5, 2019.

(30) Foreign Application Priority Data
Dec. 28, 2018 (JP) 2018-247483

(51) Int. Cl. H01M 8/18; H01M 8/0247; H01M 8/04186

(52) U.S. Cl. CPC H01M 8/188; H01M 2300/0028; H01M 8/04186; H01M 8/0247

(57) ABSTRACT

A redox flow battery includes a first nonaqueous liquid that contains a first nonaqueous solvent, a first electrode mediator, and metal ions; a first electrode at least in part in contact with the first nonaqueous liquid; a second nonaqueous liquid that contains a second nonaqueous solvent; a second electrode that is a counter electrode with respect to the first electrode and is at least in part in contact with the second nonaqueous liquid; and a separator that has a plurality of pores and separates the first and second nonaqueous liquids from each other. The plurality of pores have an average diameter larger than a size of each of the metal ions and smaller than a size of an aggregate containing molecules of the first electrode mediator solvated with the first nonaqueous solvent.

### BACKGROUND

### 1. Technical Field

The present disclosure relates to a redox flow battery.

### 2. Description of the Related Art

Japanese Unexamined Patent Application Publication (Translation of PCT Application) No. 2014-524124 discloses a redox flow battery system that includes an energy reservoir containing a redox mediator.

International Publication No. 2016/208123 discloses a redox flow battery in which a redox species is used.

### SUMMARY

One non-limiting and exemplary embodiment provides a redox flow battery that offers a reduced capacity loss caused by the crossover of a redox mediator.

In one general aspect, the techniques disclosed here feature a redox flow battery. The redox flow battery includes a first nonaqueous liquid that contains a first nonaqueous solvent, a first electrode mediator, and metal ions; a first electrode at least in part in contact with the first nonaqueous liquid; a second nonaqueous liquid that contains a second nonaqueous solvent; a second electrode that is a counter electrode with respect to the first electrode and is at least in part in contact with the second nonaqueous liquid; and a separator that has a plurality of pores and separates the first and second nonaqueous liquids from each other. The plurality of pores have an average diameter larger than a size of each of the metal ions and smaller than a size of an aggregate containing molecules of the first electrode mediator when solvated with the first nonaqueous solvent.

According to certain aspects of the present disclosure, the crossover of redox mediator(s) is reduced. There is, therefore, provided a redox flow battery that maintains a high capacity for an extended period of time.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating an outline structure of a redox flow battery according to Embodiment 1;

FIG. 2 is a block diagram illustrating an outline structure of a redox flow battery according to Embodiment 2;

FIG. 3 is a schematic diagram illustrating an outline structure of a redox flow battery according to Embodiment 3; and

FIG. 4 is a graph representing the open-circuit voltage of the electrochemical cells of Example 1, Example 2, and Comparative Example 1.

### DETAILED DESCRIPTION

A redox flow battery according to a first aspect of the present disclosure includes:

a first nonaqueous liquid that contains a first nonaqueous solvent, a first electrode mediator, and metal ions;

a first electrode at least in part in contact with the first nonaqueous liquid;

a second nonaqueous liquid that contains a second nonaqueous solvent;

a second electrode that is a counter electrode with respect to the first electrode and is at least in part in contact with the second nonaqueous liquid; and

a separator that has a plurality of pores and separates the first and second nonaqueous liquids from each other.

The plurality of pores have an average diameter larger than a size of each of the metal ions and smaller than a size of an aggregate containing molecules of the first electrode mediator solvated with the first nonaqueous solvent.

In the first aspect, the average diameter of the plurality of pores in the separator is smaller than the size of the first electrode mediator when solvated with the first nonaqueous solvent. This reduces passing of the first electrode mediator through the separator. The crossover, or movement from the first to the second nonaqueous liquid, of the first electrode mediator is therefore reduced. By virtue of the reduced crossover of the first electrode mediator, a redox flow battery is realized that maintains a high capacity for an extended period of time.

In a second aspect of the present disclosure, for example, the separator in the redox flow battery according to the first aspect may be made of porous glass.

In a third aspect of the present disclosure, for example, the average diameter of the plurality of pores in the redox flow battery according to the first or second aspect may be larger than or equal to 0.5 nm and may be smaller than or equal to 15 nm.

In a fourth aspect of the present disclosure, for example, the average diameter of the plurality of pores in the redox flow battery according to any one of the first to third aspects may be larger than or equal to 0.5 nm and may be smaller than or equal to 5 nm. In the second to fourth aspects, a redox flow battery is realized that maintains a high capacity for an extended period of time.

In a fifth aspect of the present disclosure, for example, the metal ions in the redox flow battery according to any one of the first to fourth aspects may include at least one selected from the group consisting of lithium ions, sodium ions, magnesium ions, and aluminum ions.

In a sixth aspect of the present disclosure, for example, the redox flow battery according to any one of the first to fifth aspects may further include a first active material at least in part in contact with the first nonaqueous liquid and a first circulator configured to circulate the first nonaqueous liquid between the first electrode and the first active material. The first electrode mediator may be oxidized or reduced by the first electrode, and the first electrode mediator may be oxidized or reduced by the first active material. In the fifth or six aspect, the redox flow battery has a high energy density by volume.

In a seventh aspect of the present disclosure, for example, the redox flow battery according to any one of the first to sixth aspects may further include a first active material at least in part in contact with the first nonaqueous liquid. The first electrode mediator may be an aromatic compound. The metal ions may be lithium ions, the first nonaqueous liquid may be capable of dissolving lithium, and the first active material may be a substance having a property to store and release lithium. The first nonaqueous liquid may have an electrical potential of smaller than or equal to 0.5 V vs. Li⁺/Li. The separator may be made of silica-based porous glass. In the seventh aspect, a low-potential first nonaqueous liquid can be used because silica-based porous glass is not easily damaged by the first nonaqueous liquid. By virtue of this, the redox flow battery exhibits a high discharge voltage and therefore has a high energy density by volume.

In an eighth aspect of the present disclosure, for example, the aromatic compound in the redox flow battery according to the seventh aspect may include at least one selected from the group consisting of biphenyl, phenanthrene, trans-stilbene, cis-stilbene, triphenylene, o-terphenyl, m-terphenyl, p-terphenyl, anthracene, benzophenone, acetophenone, butyrophenone, valerophenone, acenaphthene, acenaphthylene, fluoranthene, and benzil. In the eighth aspect, the redox flow battery exhibits a high discharge voltage and therefore has a high energy density by volume.

In a ninth aspect of the present disclosure, for example, the redox flow battery according to any one of the first to eighth aspects may further include a second active material at least in part in contact with the second nonaqueous liquid. The second nonaqueous liquid may contain a second electrode mediator. The second electrode mediator may be oxidized or reduced by the second electrode, and the second electrode mediator may be oxidized or reduced by the second active material. The average diameter of the pores is smaller than smallest one of the size of the aggregate containing molecules of the first electrode mediator solvated with the first nonaqueous solvent and a size of an aggregate containing molecules of the second electrode mediator solvated with the second nonaqueous solvent. In the ninth aspect, a redox flow battery is realized that maintains a high capacity for an extended period of time by virtue of reduced crossover of the first and second electrode mediators.

In a tenth aspect of the present disclosure, for example, the second electrode mediator in the redox flow battery according to the ninth aspect may include at least one selected from the group consisting of tetrathiafulvalene, triphenylamine, and derivatives thereof.

In an eleventh aspect of the present disclosure, for example, the first and second nonaqueous solvents in the redox flow battery according to any one of the first to tenth aspects may each independently contain a compound that has at least one selected from the group consisting of a carbonate group and an ether group.

In a twelfth aspect of the present disclosure, for example, the first and second nonaqueous solvents in the redox flow battery according to the eleventh aspect may each independently contain at least one selected from the group consisting of propylene carbonate, ethylene carbonate, dimethyl carbonate, ethyl methyl carbonate, and diethyl carbonate.

In a thirteenth aspect of the present disclosure, for example, the first and second nonaqueous solvents in the redox flow battery according to the eleventh aspect may each independently contain at least one selected from the group consisting of dimethoxyethane, diethoxyethane, dibutoxyethane, diglyme, triglyme, tetraglyme, polyethylene glycol dialkyl ethers, tetrahydrofuran, 2-methyltetrahydrofuran, 2,5-dimethyltetrahydrofuran, 1,3-dioxolane, and 4-methyl-1,3-dioxolane. In the tenth to thirteenth aspects, the redox flow battery exhibits a high discharge voltage and therefore has a high energy density by volume.

The present disclosure in its another aspect provides a redox flow battery that includes:

a first nonaqueous liquid that contains at least one first nonaqueous solvent, at least one first electrode mediator, and metal ions;

a first electrode at least in part in contact with the first nonaqueous liquid;

a second nonaqueous liquid that contains at least one second nonaqueous solvent;

a second electrode that is a counter electrode with respect to the first electrode and is at least in part in contact with the second nonaqueous liquid; and

a separator that has a plurality of pores and separates the first and second nonaqueous liquids from each other, wherein the plurality of pores have an average diameter larger than or equal to 0.5 nm and smaller than or equal to 15 nm.

The present disclosure in its another aspect provides a redox flow battery that includes:

a first nonaqueous liquid that contains at least one first nonaqueous solvent, at least one first electrode mediator, and metal ions;

a first electrode at least in part in contact with the first nonaqueous liquid;

a second nonaqueous liquid that contains at least one second nonaqueous solvent;

a second electrode that is a counter electrode with respect to the first electrode and is at least in part in contact with the second nonaqueous liquid; and

a separator that has a plurality of pores and separates the first and second nonaqueous liquids from each other, wherein the plurality of pores have an average diameter larger than the size of the metal ions and smaller than the size of aggregates containing two molecules of the first electrode mediator solvated with the first nonaqueous solvent.

The present disclosure in its another aspect provides a redox flow battery that includes:

a first nonaqueous liquid that contains at least one first nonaqueous solvent, at least one first electrode mediator, and metal ions;

a first electrode at least in part in contact with the first nonaqueous liquid;

a second nonaqueous liquid that contains at least one second nonaqueous solvent;

a second electrode that is a counter electrode with respect to the first electrode and is at least in part in contact with the second nonaqueous liquid; and

a separator that has a plurality of pores and separates the first and second nonaqueous liquids from each other, wherein the plurality of pores have an average diameter larger than the size of the metal ions and smaller than the size of aggregates containing four molecules of the first electrode mediator solvated with the first nonaqueous solvent.

In the following, embodiments of the present disclosure are described with reference to drawings.

### Embodiment 1

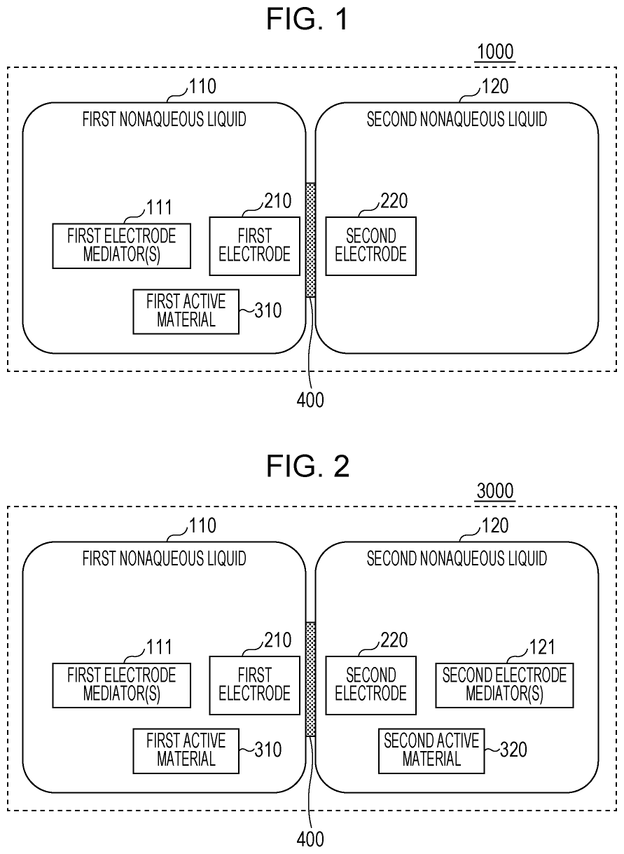

FIG. 1 is a block diagram illustrating an outline structure of a redox flow battery 1000 according to Embodiment 1.

The redox flow battery 1000 according to Embodiment 1 includes a first nonaqueous liquid 110, a first electrode 210, a second nonaqueous liquid 120, a second electrode 220, and a separator 400.

The first nonaqueous liquid 110 is an electrolyte containing at least one first nonaqueous solvent with at least one first electrode mediator 111 and metal ions dissolved therein.

The first electrode 210 is an electrode at least in part in contact with the first nonaqueous liquid 110.

The second electrode 220 is a counter electrode with respect to the first electrode 210 and is an electrode at least in part in contact with the second nonaqueous liquid 120.

The separator 400 has multiple pores. The pores in the separator 400 allow the metal ions to move between the first nonaqueous liquid 110 and the second nonaqueous liquid 120. The separator 400, moreover, separates the first and second nonaqueous liquids 110 and 120 from each other.

The shape of the separator 400 is, for example, like a plate. For example, the multiple pores in the separator 400 are each in the first surface, which is in contact with the first nonaqueous liquid 110, of the separator 400 and in the second surface, which is in contact with the second nonaqueous liquid 120, of the separator 400. Inside the separator 400, at least one of the pores may be connected to another. The pores in the separator 400, moreover, may form a continuous pore created in a three-dimensional shape, but each of the pores may be independent of each other. The pores may include multiple continuous pores and multiple independent pores. Each of the pores may be a through hole running through the separator 400 in the direction of thickness.

The separator 400 contains, for example, porous glass. It may be that the separator 400 is substantially a piece of porous glass, but the separator 400 may contain impurities besides porous glass. The average diameter of pores in the porous glass can be controlled by customizing the raw-material composition, heating conditions, etc., in the production of the porous glass. A feature of porous glass, in particular, is that it can be produced to have thin pores with a narrow diameter distribution and an average diameter smaller than or equal to 50 nm.

The average diameter of the pores in the separator 400 is larger than the size of the metal ions and smaller than the size of the first electrode mediator 111 when solvated with the first nonaqueous solvent. This ensures the crossover, or movement to the second nonaqueous liquid 120, of the first electrode mediator 111 is reduced but the metal ions still pass through the separator 400. The reduced crossover of the first electrode mediator 111 into the second nonaqueous liquid 120 ensures that the first electrode mediator 111, dissolved in the first nonaqueous liquid 110 and contributing to charge and discharge reactions, keeps a constant concentration in the first nonaqueous liquid 110. As a result, the redox flow battery 1000 maintains its charge-discharge capacity for an extended period of time.

In the first nonaqueous liquid 110, molecules of the first electrode mediator 111 solvated with the first nonaqueous solvent can gather into aggregates. In other words, aggregates containing molecules of the first electrode mediator 111 solvated with the first nonaqueous solvent may be dispersed and migrating in the first nonaqueous liquid 110. If the average diameter of the pores in the separator 400 is smaller than the size of these aggregates, therefore, the crossover of the first electrode mediator 111 into the second nonaqueous liquid 120 may be reduced. To take an example, the average diameter of the pores in the separator 400 may be smaller than the size of aggregates containing two molecules of the first electrode mediator 111 solvated with the first nonaqueous solvent or may be smaller than aggregates containing four molecules of the first electrode mediator 111 solvated with the first nonaqueous solvent. The size of aggregates can be calculated by, for example, the same method as that for the size of the first electrode mediator 111, which will be described later herein.

The mechanism for ionic conduction through the separator 400 is different from that through a known ceramic solid electrolyte membrane. Ionic conduction through a known ceramic solid electrolyte membrane is based on the mechanism of ionic conduction by the solid electrolyte. If the solid electrolyte membrane is so dense that little of the liquid electrolyte can pass, therefore, only metal ions pass through the solid electrolyte membrane, and the crossover, which in this case is the penetration of the liquid electrolyte and the electrolytic substance therein through the solid electrolyte membrane, is prevented. Solid electrolyte membranes, however, are of low ionic conductivity, which means it can be difficult to achieve a sufficiently low electrical resistance with a solid electrolyte membrane. That is, with a solid electrolyte membrane, it can be difficult to take out an electric current adequate for practical use. The separator 400 according to this embodiment, by contrast, conducts the metal ions that should be, by taking advantage of the difference between the size of the metal ions and the size of a solvated form of the first electrode mediator 111. Since the separator 400 itself has little negative impact on ionic conductivity, the separator 400 according to this embodiment helps achieve a degree of ionic conductivity comparable to that of a liquid electrolyte. With the separator 400 according to this embodiment, therefore, the electric current taken out is adequate for practical use.

The average diameter of the pores in the separator 400 is determined according to the size of the metal ions, the size of the first electrode mediator 111, and the solvation status of the first electrode mediator 111. The average diameter of the pores is, for example, larger than or equal to 0.5 nm and smaller than or equal to 15 nm or is larger than or equal to 0.5 nm and smaller than or equal to 5.0 nm. This ensures the crossover of the first electrode mediator 111 is reduced sufficiently but the metal ions still pass through the separator 400.

The metal ions in the redox flow battery 1000 according to Embodiment 1 include, for example, at least one selected from the group consisting of lithium ions, sodium ions, magnesium ions, and aluminum ions. The size of metal ions varies according to their coordination by a solvent or by another ionic species. As mentioned herein, the size of metal ions means, for example, the diameter of the metal ions. To take some examples, the diameter of lithium ions is larger than or equal to 0.12 nm and smaller than or equal to 0.18 nm, the diameter of sodium ions is larger than or equal to 0.20 nm and smaller than or equal to 0.28 nm, the diameter of magnesium ions is larger than or equal to 0.11 nm and smaller than or equal to 0.18 nm, and the diameter of aluminum ions is larger than or equal to 0.08 nm and smaller than or equal to 0.11 nm. An average diameter of the pores larger than or equal to 0.5 nm therefore ensures that these kinds of metal ions pass through the separator 400 sufficiently well.

The first electrode mediator 111 can be, for example, aromatic compounds including at least one selected from the group consisting of biphenyl, phenanthrene, trans-stilbene, cis-stilbene, triphenylene, o-terphenyl, m-terphenyl, p-terphenyl, anthracene, benzophenone, acetophenone, butyrophenone, valerophenone, acenaphthene, acenaphthylene, fluoranthene, and benzil. The size of native molecules of the first electrode mediator 111 and that of the first electrode mediator 111 when solvated with the first nonaqueous solvent can be determined by, for example, density-functional theory ab initio computations with the basis set 6-31G. As mentioned herein, the size of the first electrode mediator 111 when solvated with the first nonaqueous solvent means, for example, the diameter of the smallest sphere that can contain a molecule of the first electrode mediator 111 solvated with the first nonaqueous solvent. The size of native molecules of the first electrode mediator 111 is, for example, larger than or equal to approximately 1 nm. The size of the first electrode mediator 111 when solvated with the first nonaqueous solvent varies, for example according to the kind of and coordination by the first nonaqueous solvent, but, to take an example, the size of the solvated form of the first electrode mediator 111 is larger than 5 nm. There is no particular upper limit, but the size of the first electrode mediator 111 when solvated with the first nonaqueous solvent is, for example, smaller than or equal to 8 nm. An average diameter of the pores in the separator 400 smaller than or equal to 5 nm therefore ensures that the penetration of molecules of the first electrode mediator 111 solvated with the first nonaqueous solvent will be reduced sufficiently. The average diameter of the pores in the separator 400, however, can be adjusted to any desired value, for example by changing the kind of the first electrode mediator 111 used, the number of coordinating molecules of the first nonaqueous solvent, and the kind of the first nonaqueous solvent, which influences the coordination number. The state of coordination of the first electrode mediator 111 by the first nonaqueous solvent and the number of coordinating molecules of the first nonaqueous solvent can be estimated from, for example, data from NMR of the first nonaqueous liquid 110.

The average diameter of the pores in the separator 400 is, for example, the mean diameter of the pores calculated according to the distribution of diameters of the pores. The distribution of diameters of the pores can be obtained by, for example, measuring the adsorption isotherm by gas adsorption with nitrogen and converting the data by the BJH (Barrett-Joyner-Halenda) method. The adsorption isotherm data may be obtained by gas adsorption with argon instead. The average diameter of the pores may alternatively be measured by mercury intrusion porosimetry, direct observation under an electronic microscope, positron annihilation spectroscopy, etc.

If the separator 400 contains porous glass, the composition of the porous glass is not critical unless the porous glass dissolves in or reacts with the first nonaqueous liquid 110 or second nonaqueous liquid 120. Examples of porous glass materials that can be used include glass materials containing silica, titania, zirconia, yttria, ceria, lanthanum oxide, etc.

As described later herein, if the first electrode mediator 111 is an aromatic compound and if lithium is dissolved in the first nonaqueous liquid 110, the first nonaqueous liquid 110 exhibits a very low electrical potential smaller than or equal to 0.5 V vs. Li⁺/Li. In this case the porous glass, which can be contained in the separator 400, may be of a type inert to the strongly reducing first nonaqueous liquid 110. An example of such a porous glass material is silica-based porous glass. The term “-based” means that the specified component is the most abundant by weight in the porous glass, for example making up greater than or equal to 50% by weight. It may be that the porous glass is substantially silica.

If the separating membrane in a nonaqueous redox flow battery is made with a ceramic electrolyte that conducts metal ions, dendrites can form along crystal grain boundaries as a result of nearby local high currents. The ceramic electrolyte itself, furthermore, is of low ionic conductivity. This nonaqueous redox flow battery, therefore, may be difficult to charge and discharge at high current densities. If the separator 400 is made of silica-based porous glass, by contrast, the grain boundaries are few in number because glass, which forms porous glass, is an amorphous material. No local high currents therefore occur, and the formation of dendrites at the separator 400 is limited. With this separator 400, therefore, a redox flow battery 1000 can be realized that can be charged and discharged at high current densities.

If the separating membrane in a nonaqueous redox flow battery is made with a glass electrolyte that conducts metal ions and is used in combination with a low-potential negative electrode liquid electrolyte, the membrane can change its nature through the reduction of elements forming part of the glass electrolyte, such as titanium. This nonaqueous redox flow battery, therefore, may be difficult to be longer-lived. If the separator 400 is made of silica-based porous glass, by contrast, the change in the nature of the separator 400 that occurs with a low-potential negative electrode liquid electrolyte is limited. With this separator 400, therefore, a longer-lived redox flow battery 1000 can be realized.

If the separating membrane in a nonaqueous redox flow battery is made with a flexible polymeric solid electrolyte, the polymeric solid electrolyte can dissolve or swell because of the liquid electrolytes in the nonaqueous redox flow battery. Once this occurs, the liquid electrolytes at the two electrodes, redox mediators in particular, are mixed together while the nonaqueous redox flow battery is being charged and discharged. This can cause a significant decrease in the charge-discharge capacity of the nonaqueous redox flow battery. If the separator 400 is made of silica-based porous glass, by contrast, the dissolution or swelling of the separator 400 caused by the liquid electrolytes is limited. With this separator 400, therefore, a redox flow battery 1000 can be realized that have good charge-discharge characteristics.

The separator 400 serves as a porous membrane through which the metal ions can pass. As long as the separator 400 is permeable to the metal ions and remains mechanically strong enough for the redox flow battery 1000 to operate, the porosity of the separator 400 is not critical. The porosity of the separator 400 may be higher than or equal to 10% and lower than or equal to 50% or may be higher than or equal to 20% and lower than or equal to 40%. The porosity of the separator 400 can be measured by, for example, the following method. First, the volume V and weight W of the separator 400 are measured. Substituting the measured volume V and weight W and the density D of the material for the separator 400 into the equation below gives the porosity.

Porosity(%)=100×(V−(W/D))/V

As long as the separator 400 is permeable to the metal ions and mechanically strong enough for the redox flow battery 1000 to operate, the thickness of the separator 400 is not critical. The thickness of the separator 400 may be larger than or equal to 10 μm and smaller than or equal to 1 mm, may be larger than or equal to 10 μm and smaller than or equal to 500 μm, or may be larger than or equal to 50 μm and smaller than or equal to 200 μm.

The total pore volume of the separator 400 is not critical. The total pore volume of the separator 400 may be larger than or equal to 0.05 mL/g and smaller than or equal to 0.5 mL/g. The total pore volume of the separator 400 can be measured by, for example, gas adsorption with nitrogen or argon.

The specific surface area of the separator 400 is not critical. The specific surface area of the separator 400 may be larger than or equal to 15 m²/g and smaller than or equal to 3600 m²/g. The specific surface area of the separator 400 may be larger than or equal to 200 m²/g and smaller than or equal to 500 m²/g. The specific surface area of the separator 400 can be measured by, for example, a BET (Brunauer-Emmett-Teller) analysis by nitrogen or argon gas adsorption.

It is not critical how to produce the separator 400 as long as multiple pores are created in the separator 400 with an average diameter larger than the size of the metal ions and smaller than the size of the first electrode mediator 111 when solvated with the first nonaqueous solvent. If the separator 400 is made of porous glass, the separator 400 can be produced by, for example, the following method. First, two or more raw materials for glass are melted and mixed together to give a glass composition. The raw materials for glass may include silica and boric acid. That is, the glass composition may be borosilicate glass. The glass composition may be shaped while being prepared. Then phase separation is induced by heating the glass composition. The phase-separated glass composition contains multiple phases with different compositions. The phase-separated glass composition has, for example, a silica-containing phase and a boron oxide-containing phase. Then one of the phases in the glass composition is removed by acid treatment. For example, a boron oxide-containing phase is removed by acid treatment. This gives porous glass with pores created therein. The average diameter of the pores can be adjusted by customizing the chemical makeup of the glass composition, heating conditions, etc. The resulting porous glass can be used as the separator 400.

In this configuration, a redox flow battery 1000 is realized that has a large charge capacity and maintains its charge-discharge capacity for an extended period of time.

If the separator 400 includes porous glass, the separator 400 does not react easily with the first and second nonaqueous liquids 110 and 120 upon contact with the first and second nonaqueous liquids 110 and 120. The shape of the pores in the separator 400 is therefore maintained. The separator 400 reduces the crossover of the first electrode mediator 111 while allowing the metal ions to pass through. Greater flexibility is therefore allowed in selecting the first nonaqueous liquid 110 and the first electrode mediator 111, which is dissolved in the first nonaqueous liquid 110. The limits to which the charge and discharge potentials should be controlled are expanded in consequence, helping increase the charge capacity of the redox flow battery 1000.

The first nonaqueous solvent in the redox flow battery 1000 according to Embodiment 1, contained in the first nonaqueous liquid 110, may include a compound that has a carbonate group and/or an ether group.

For compounds having a carbonate group, at least one selected from the group consisting of propylene carbonate (PC), ethylene carbonate (EC), dimethyl carbonate (DMC), ethyl methyl carbonate (EMC), and diethyl carbonate (DEC), for example, can be used.

For compounds having an ether group, at least one selected from the group consisting of dimethoxyethane, diethoxyethane, dibutoxyethane, diglyme (diethylene glycol dimethyl ether), triglyme (triethylene glycol dimethyl ether), tetraglyme (tetraethylene glycol dimethyl ether), polyethylene glycol dialkyl ethers, tetrahydrofuran, 2-methyltetrahydrofuran, 2,5-dimethyltetrahydrofuran, 1,3-dioxolane, and 4-methyl-1,3-dioxolane, for example, can be used.

The first nonaqueous liquid 110 in the redox flow battery 1000 according to Embodiment 1 may be an electrolyte containing at least one first nonaqueous solvent as described above and at least one electrolytic salt. The electrolytic salt may be at least one salt selected from the group consisting of LiBF₄, LiPF₆, LiTFSI (lithium bis(trifluoromethanesulfonyl)imide), LiFSI (lithium bis(fluorosulfonyl)imide), LiCF₃SO₃, LiClO₄, NaBF₄, NaPF₆, NaTFSI, NaFSI, NaCF₃SO₃, NaClO₄, Mg(BF₄)₂, Mg(PF₆)₂, Mg(TFSI)₂, Mg(FSI)₂, Mg(CF₃SO₃)₂, Mg(ClO₄)₂, AlCl₃, AlBr₃, and Al(TFSI)₃. The first nonaqueous solvent may have a high dielectric constant and may be only weakly reactive with metal ions. The electrochemical window of the first nonaqueous solvent, furthermore, may be narrower than or equal to approximately 4 V.

Similar to the first nonaqueous solvent, the second nonaqueous solvent, contained in the second nonaqueous liquid 120, in the redox flow battery 1000 according to Embodiment 1 may include a compound that has a carbonate group and/or an ether group. The second nonaqueous solvent may be of the same kind as the first nonaqueous solvent or may be different from the first nonaqueous solvent.

The first electrode mediator 111 in the redox flow battery 1000 according to Embodiment 1 can be a substance that dissolves in the first nonaqueous liquid 110 and is electrochemically oxidized and reduced there.

If the first and second electrodes 210 and 220 are the negative and positive electrodes, respectively, in the redox flow battery 1000 according to Embodiment 1, the first electrode mediator 111 may be an aromatic compound, such as biphenyl, phenanthrene, trans-stilbene, cis-stilbene, triphenylene, o-terphenyl, m-terphenyl, p-terphenyl, anthracene, benzophenone, acetophenone, butyrophenone, valerophenone, acenaphthene, acenaphthylene, fluoranthene, or benzil. The first electrode mediator 111 may be a metallocene compound, such as ferrocene. The first electrode mediator 111 may be a heterocyclic compound, such as a tetrathiafulvalene derivative, a bipyridyl derivative, a thiophene derivative, a thianthrene derivative, a carbazole derivative, or phenanthroline. The first electrode mediator 111 may optionally be a combination of two or more such compounds.

In particular, if the first electrode mediator 111 is an aromatic compound and if lithium is dissolved in the first nonaqueous liquid 110, the first nonaqueous liquid 110 exhibits a very low electrical potential smaller than or equal to 0.5 V vs. LOLL If this first nonaqueous liquid 110 is applied to the redox flow battery 1000, therefore, the battery voltage achieved is higher than or equal to 3.0 V. A battery is therefore realized that has a high energy density. In this case, the first nonaqueous liquid 110 is strongly reducing. For sufficient resistance to the first nonaqueous liquid 110 to be ensured, a suitable separator 400 is a piece of silica-based porous glass.

Incidentally, the first electrode 210 may be the positive electrode of the redox flow battery 1000 according to Embodiment 1, and the second electrode 220 may be the negative electrode.

If the first electrode 210 is the positive electrode in the redox flow battery 1000 according to Embodiment 1 with the second electrode 220 being the negative electrode, the first electrode mediator 111 may be a heterocyclic compound, such as a tetrathiafulvalene derivative, a bipyridyl derivative, a thiophene derivative, a thianthrene derivative, a carbazole derivative, or phenanthroline. The first electrode mediator 111 may be, for example, a triphenylamine derivative. The first electrode mediator 111 may be a metallocene compound, such as titanocene. The first electrode mediator 111 may optionally be a combination of two or more such compounds.

The molecular weight of the first electrode mediator 111 is not critical. The molecular weight of the first electrode mediator 111 may be larger than or equal to 100 and smaller than or equal to 500 or may be larger than or equal to 100 and smaller than or equal to 300.

In the redox flow battery 1000 according to Embodiment 1, the first electrode mediator 111 is oxidized or reduced by the first electrode 210, for example through the contact of the first nonaqueous liquid 110 with at least part of the first electrode 210.

The first electrode 210 may be an electrode having a surface that acts as a reaction field for the first electrode mediator 111.

In this case, the first electrode 210 can be made of a material stable against the first nonaqueous liquid 110. The material stable against the first nonaqueous liquid 110 may be, for example, a material insoluble in the first nonaqueous liquid 110. In addition, the first electrode 210 can be made of a material stable against the electrochemical reactions that occur at the electrode. For example, the first electrode 210 can be a piece of metal or carbon. The metal may be stainless steel, iron, copper, nickel, etc.

The first electrode 210 may be one structured to have an increased surface area. The electrode structured to have an increased surface area may be, for example, a piece of mesh, a piece of nonwoven fabric, a plate with a roughened surface, or a sintered porous medium. This increases the specific surface area of the first electrode 210. The oxidation or reduction of the first electrode mediator 111 proceeds more efficiently in consequence.

The second electrode 220 can be, for example, an electrode as described by way of example in relation to the first electrode 210. The first and second electrodes 210 and 220 may be electrodes made of different materials or may be electrodes made of the same material.

The redox flow battery 1000 may further include a first active material 310 at least in part in contact with the first nonaqueous liquid 110. In other words, the first active material 310 only needs to be in contact with the first nonaqueous liquid 110 at least in part. The first active material 310 can be a substance that chemically oxidizes and reduces the first electrode mediator 111. The first active material 310 is, for example, insoluble in the first nonaqueous liquid 110.

The first active material 310 can be a compound capable of reversibly storing and releasing metal ions. By selecting a low- or high-potential compound as the first active material 310 according to the electrical potential of the first electrode mediator 111, the redox flow battery 1000 is made to operate.

Examples of low-potential compounds that can act as the first active material 310 include metals, metal oxides, carbon, and silicon. Examples of metals include lithium, sodium, magnesium, aluminum, and tin. Examples of metal oxides include titanium oxide. In particular, in a system in which the first electrode mediator 111 is an aromatic compound and in which lithium is dissolved in the first nonaqueous liquid 110, the low-potential compound can be a compound that contains at least one selected from the group consisting of carbon, silicon, aluminum, and tin.

Examples of high-potential compounds that can act as the first active material 310 include metal oxides such as lithium iron phosphate, LCO (LiCoO₂), LMO (LiMn₂O₄), and NCA (lithium nickel cobalt aluminum oxides).

By employing a configuration in which a first active material 310 chemically oxidizes and reduces the first electrode mediator 111, it is ensured that the charge-discharge capacity of the redox flow battery 1000 depends not on the solubility of the first electrode mediator 111 but on the capacity of the first active material 310. As a result, a redox flow battery 1000 is realized that has a high energy density.

Description of the Charging and Discharging Processes

The processes of charge and discharge of the redox flow battery 1000 according to Embodiment 1 are described below.

Specifically, an operation example configured as described below is described by way of example to illustrate the charging and discharging processes. The first electrode 210 may be the negative electrode or may be the positive electrode. The second electrode 220 may be the positive electrode or may be the negative electrode. Although in the above description the first electrode 210 is the negative electrode with the second electrode 220 being the positive electrode, the following example is described with the first electrode 210 as the positive electrode and the second electrode 220 as the negative electrode.

The first electrode 210 is the positive electrode and is a piece of carbon black.

The first nonaqueous liquid 110 is an ether solution in which the first electrode mediator 111 is dissolved.

The first electrode mediator 111 is tetrathiafulvalene (hereinafter described as TTF).

The first active material 310 is lithium iron phosphate (hereinafter described as LiFePO₄).

The second electrode 220 is the negative electrode and is a piece of lithium metal.

### Description of the Charging Process

First, charging reactions are described.

The battery 1000 is charged through the application of a voltage across the first and second electrodes 210 and 220.

### Reaction at the Negative Electrode

The application of a voltage causes electrons to be supplied to the second electrode 220, which is the negative electrode, from the outside of the redox flow battery 1000. At the second electrode 220, which is the negative electrode, reduction occurs in consequence. The negative electrode therefore goes into its charged state.

In this operation example, for instance, the following reaction takes place.

Li⁺+e⁻→Li

### Reactions at the Positive Electrode

At the first electrode 210, which is the positive electrode, the application of a voltage causes the oxidation of the first electrode mediator 111. That is, the first electrode mediator 111 is oxidized on the surface of the first electrode 210. Electrons are released from the first electrode 210 to the outside of the redox flow battery 1000 in consequence.

In this operation example, for instance, the following reaction takes place.

TTF→TTF²⁺+2e⁻

The first electrode mediator 111 oxidized at the first electrode 210 is reduced by the first active material 310. In other words, the first active material 310 is oxidized by the first electrode mediator 111.

2LiFePO₄+TTF²⁺→2FePO₄+2Li⁺+TTF

These charging reactions can proceed until the first active material 310 goes into its charged state or the second electrode 220 goes into its charged state, whichever is reached first.

### Description of the Discharging Process

Next, discharging reactions are described.

The first active material 310 and the second electrode 220 are in their charged state.

In the discharging reactions, electricity is taken out from between the first and second electrodes 210 and 220.

### Reaction at the Negative Electrode

At the second electrode 220, which is the negative electrode, oxidation occurs. The negative electrode therefore goes into its discharged state. Electrons are released from the second electrode 220 to the outside of the redox flow battery 1000 in consequence.

In this operating example, for instance, the following reaction takes place.

Li→Li⁺+e⁻

### Reactions at the Positive Electrode

The battery discharge causes electrons to be supplied to the first electrode 210, which is the positive electrode, from the outside of the redox flow battery 1000. On the first electrode 210, the reduction of the first electrode mediator 111 occurs in consequence. That is, the first electrode mediator 111 is reduced on the surface of the first electrode 210.

In this operation example, for instance, the following reaction takes place.

TTF²⁺+2e⁻→TTF

Some of the lithium ions (Li⁺) are supplied from the second electrode 220 side through the separator 400.

The first electrode mediator 111 reduced at the first electrode 210 is oxidized by the first active material 310. In other words, the first active material 310 is reduced by the first electrode mediator 111.

2FePO₄+2Li⁺+TTF→2LiFePO₄+TTF²⁺

These discharging reactions can proceed until the first active material 310 goes into its discharged state or the second electrode 220 goes into its discharged state, whichever is reached first.

### Embodiment 2

In the following, Embodiment 2 is described. Any details that have already been described above in Embodiment 1 are omitted where appropriate.

FIG. 2 is a block diagram illustrating an outline structure of a redox flow battery 3000 according to Embodiment 2 by way of example.

Besides having the configuration of the redox flow battery 1000 according to Embodiment 1 above, the redox flow battery 3000 according to Embodiment 2 is configured as described below.

That is, the redox flow battery 3000 according to Embodiment 2 further includes at least one second electrode mediator 121 and a second active material 320.

The average diameter of the pores in the separator 400 in the redox flow battery 3000 according to Embodiment 2 is smaller than the size of the first electrode mediator 111 when solvated with the first nonaqueous solvent or the size of the second electrode mediator 121 when solvated with the second nonaqueous solvent, whichever is smaller.

Like that of the first electrode mediator 111, the size of the second electrode mediator 121 when solvated with the second nonaqueous solvent can be determined by, for example, density-functional theory ab initio computations with the basis set of 6-31G. As mentioned herein, the size of the second electrode mediator 121 when solvated with the second nonaqueous solvent means, for example, the diameter of the smallest sphere that can contain a molecule of the second electrode mediator 121 solvated with the second nonaqueous solvent. The state of coordination of the second electrode mediator 121 by the second nonaqueous solvent and the number of coordinating molecules of the second nonaqueous solvent can be estimated from, for example, data from NMR of the second nonaqueous liquid 120.

In this configuration, a redox flow battery 3000 is realized that has a large charge capacity and maintains its charge-discharge characteristics for an extended period of time.

That is, configuring the separator 400 as described above will ensure that the crossover of the first and second electrode mediators 111 and 121 is reduced while the metal ions can pass. Greater flexibility is therefore allowed in selecting the first nonaqueous liquid 110, the first electrode mediator 111, which is dissolved in the first nonaqueous liquid 110, the second nonaqueous liquid 120, and the second electrode mediator 121, which is dissolved in the second nonaqueous liquid 120. The limits to which the charge and discharge potentials should be controlled are expanded in consequence, helping increase the charge capacity of the redox flow battery 3000. The separator 400, furthermore, keeps the first and second nonaqueous liquids 110 and 120 separate and prevents them from mixing together even if the two liquids have different compositions, allowing the redox flow battery 3000 to maintain its charge-discharge characteristics for an extended period of time.

The second electrode mediator 121 in the redox flow battery 3000 according to Embodiment 2 can be a substance that dissolves in the second nonaqueous liquid 120 and is electrochemically oxidized and reduced there. Specific examples of substances that can be used as the second electrode mediator 121 are the same kinds of metal-containing ionic compounds and organic compounds as mentioned in relation to the first electrode mediator 111. The second electrode mediator 121 includes, for example, at least one selected from the group consisting of tetrathiafulvalene, triphenylamine, and derivatives thereof. By using a low-potential compound as one of the first and second electrode mediators 111 and 121 and using a high-potential compound as the other, the redox flow battery 3000 is made to operate.

The first active material 310 in the redox flow battery 3000 according to Embodiment 2 can be, for example, a substance that does not dissolve in the first nonaqueous liquid 110 and chemically oxidizes and reduces the first electrode mediator 111. Like the first active material 310, the second active material 320 can be, for example, a substance that does not dissolve in the second nonaqueous liquid 120 and chemically oxidizes and reduces the second electrode mediator 121. That is, each of the first and second active materials 310 and 320 can be a compound capable of reversibly storing and releasing metal ions. By using a low-potential compound as one of the first and second active materials 310 and 320 and using a high-potential compound as the other in accordance with the electrical potentials of the first and second electrode mediators 111 and 121, the redox flow battery 3000 is made to operate.

Examples of low- and high-potential compounds that can act as the second active material 320 are the same as mentioned by way of example in relation to the first active material 310.

By employing a configuration in which first and second active materials 310 and 320 chemically oxidize and reduce the first and second electrode mediators 111 and 121, respectively, it is ensured that the charge-discharge capacity of the redox flow battery 3000 depends not on the solubility of the first and second electrode mediators 111 and 121 but on the capacity of the first and second active materials 310 and 320. As a result, a redox flow battery 3000 is realized that has a high energy density.

### Embodiment 3

In the following, Embodiment 3 is described. Any details that have already been described above in Embodiment 1 or 2 are omitted where appropriate.

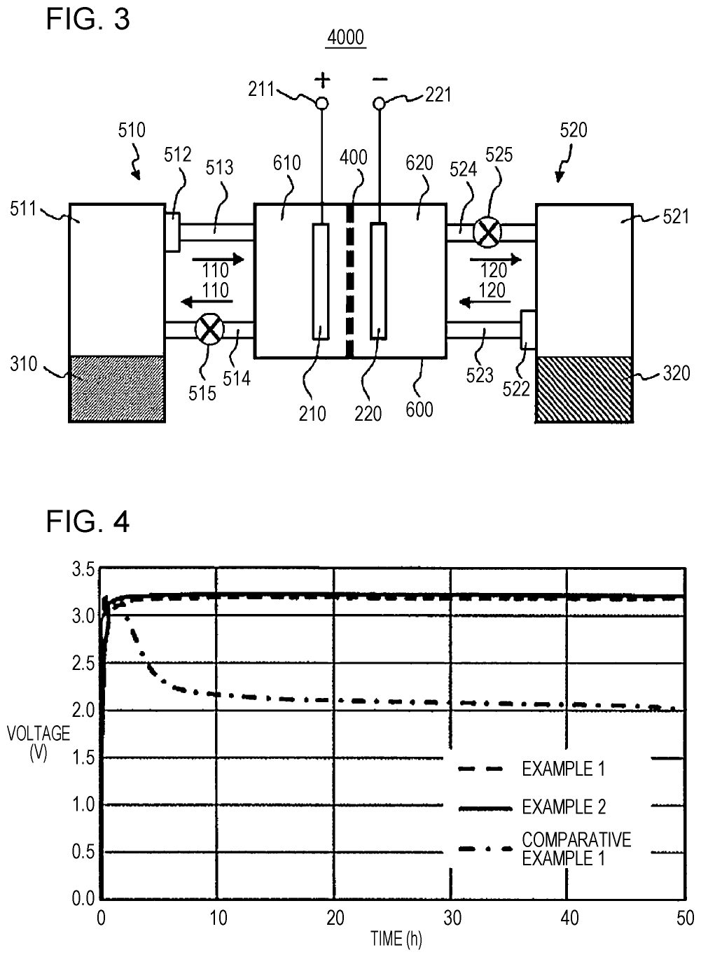

FIG. 3 is a schematic diagram illustrating an outline structure of a redox flow battery 4000 according to Embodiment 3 by way of example.

Besides having the configuration of the redox flow battery 3000 according to Embodiment 2 above, the redox flow battery 4000 according to Embodiment 3 is configured as described below.

That is, the redox flow battery 4000 according to Embodiment 3 includes a first circulator 510.

The first circulator 510 is a mechanism that circulates the first nonaqueous liquid 110 between the first electrode 210 and the first active material 310.

The first circulator 510 includes a first container 511.

The first active material 310 and the first nonaqueous liquid 110 are contained in the first container 511.

In the first container 511, the first active material 310 and the first nonaqueous liquid 110 come into contact with each other, and at least one of the following is carried out in consequence: the oxidation of the first electrode mediator 111 by the first active material 310 or the reduction of the first electrode mediator 111 by the first active material 310.

In this configuration, the first nonaqueous liquid 110 and the first active material 310 are brought into contact with each other in a first container 511. This helps, for example, increase the area of contact between the first nonaqueous liquid 110 and the first active material 310. The duration of contact between the first nonaqueous liquid 110 and the first active material 310 also becomes longer. As a result, the oxidation and reduction of the first electrode mediator 111 by the first active material 310 are carried out more efficiently.

In Embodiment 3, the first container 511 may be, for example, a tank.

The first container 511 may be, for example, filled with particles of the first active material 310, and the first nonaqueous liquid 110 may be held in the spaces between the particles of the first active material 310 with the first electrode mediator 111 dissolved therein.

As illustrated in FIG. 3, the redox flow battery 4000 according to Embodiment 3 may further include an electrochemical reaction section 600, a positive electrode terminal 211, and a negative electrode terminal 221.

The electrochemical reaction section 600 is separated by the separator 400 into a positive electrode compartment 610 and a negative electrode compartment 620. The pores in the separator 400, for example, open into the positive electrode and negative electrode compartments 610 and 620.

In the positive electrode compartment 610 is the electrode that serves as the positive electrode. In FIG. 3, the first electrode 210 is in the positive electrode compartment 610.

The positive electrode terminal 211 is coupled to the electrode that serves as the positive electrode. In FIG. 3, the positive electrode terminal 211 is coupled to the first electrode 210.

In the negative electrode compartment 620 is the electrode that serves as the negative electrode. In FIG. 3, the second electrode 220 is in the negative electrode compartment 620.

The negative electrode terminal 221 is coupled to the electrode that serves as the negative electrode. In FIG. 3, the negative electrode terminal 221 is coupled to the second electrode 220.

The positive electrode and negative electrode terminals 211 and 221 are coupled to, for example, a charger/discharger. By the charger/discharger, either a voltage is applied across the positive electrode and negative electrode terminals 211 and 221 or electricity is taken out from between the positive electrode and negative electrode terminals 211 and 221.

As illustrated in FIG. 3, the first circulator 510 in the redox flow battery 4000 according to Embodiment 3 may include piping 513, piping 514, and a pump 515. The pump 515 is, for example, provided on the piping 514. Alternatively, the pump 515 may be provided on the piping 513.

One end of the piping 513 is connected to an outlet on the first container 511 for the first nonaqueous liquid 110 to flow out.

The other end of the piping 513 is connected to one of the positive electrode and negative electrode compartments 610 and 620, whichever the first electrode 210 is in. In FIG. 3, this end of the piping 513 is connected to the positive electrode compartment 610.

One end of the piping 514 is connected to one of the positive electrode and negative electrode compartments 610 and 620, whichever the first electrode 210 is in. In FIG. 3, this end of the piping 514 is connected to the positive electrode compartment 610.

The other end of the piping 514 is connected to an inlet on the first container 511 for the first nonaqueous liquid 110 to flow out.

The first circulator 510 in the redox flow battery 4000 according to Embodiment 3 may include a first filter 512.

The first filter 512 limits the penetration of the first active material 310.

The first filter 512 is provided in the channel through which the first nonaqueous liquid 110 flows out of the first container 511 toward the first electrode 210. In FIG. 3, the first filter 512 is on the piping 513. To be exact, the first filter 512 is at the joint between the first container 511 and the piping 513. Alternatively, the first filter 512 may be provided at the joint between the first container 511 and the piping 514. The first filter 512 may be at the joint between the electrochemical reaction section 600 and the piping 513 or at the joint between the electrochemical reaction section 600 and the piping 514.

In this configuration, the outflow of the first active material 310 somewhere other than the first container 511 is reduced. For example, the outflow of the first active material 310 toward the first electrode 210 is reduced. The first active material 310 stays in the first container 511 in consequence. By virtue of this, a redox flow battery is realized in which the first active material 310 itself is not allowed to circulate. The components of the first circulator 510 are therefore prevented from getting clogged inside with the first active material 310. For example, the piping in the first circulator 510 is prevented from getting clogged inside with the first active material 310. A loss due to resistance caused by the outflow of the first active material 310 toward the first electrode 210 becomes less frequent.

The first filter 512 filters out, for example, the first active material 310. The first filter 512 may be a component that has pores smaller than the smallest diameter of the particles of the first active material 310. The material for the first filter 512 can be one that does not react with the first active material 310, the first nonaqueous liquid 110, etc. The first filter 512 may be, for example, a piece of glass-fiber filter paper, a piece of polypropylene nonwoven fabric, a piece of polyethylene nonwoven fabric, a polyethylene separator, a polypropylene separator, a polyimide separator, a polyethylene/polypropylene bilayer separator, a polypropylene/polyethylene/polypropylene three-layer separator, or a piece of metal mesh that does not react with metallic lithium.

In this configuration, the first active material 310 is prevented from flowing out of the first container 511 even if the first active material 310 flows together with the first nonaqueous liquid 110 inside the first container 511.

In FIG. 3, the first nonaqueous liquid 110 contained in the first container 511 is supplied to the positive electrode compartment 610 by passing through the first filter 512 and the piping 513.

The first electrode mediator 111, dissolved in the first nonaqueous liquid 110, is oxidized or reduced by the first electrode 210 in consequence.

Then the first nonaqueous liquid 110, with the oxidized or reduced first electrode mediator 111 dissolved therein, is supplied to the first container 511 by passing through the piping 514 and the pump 515.

As a result, the first electrode mediator 111, dissolved in the first nonaqueous liquid 110, is subjected to at least one of the following: the oxidation or reduction of the first electrode mediator 111 by the first active material 310.

The way to control the circulation of the first nonaqueous liquid 110 may be with the use of, for example, the pump 515. That is, the pump 515 is used to start and stop the supply of the first nonaqueous liquid 110 or to make adjustments, for example to the rate of supply of the first nonaqueous liquid 110, on an as-needed basis.

The way to control the circulation of the first nonaqueous liquid 110 does not need to be with the pump 515 and may be with another tool. Such a tool may be, for example, a valve.

It should be noted that in FIG. 3, the first electrode 210 is the positive electrode by way of example, with the second electrode 220 being the negative electrode.

The first electrode 210, however, can be the negative electrode if the second electrode 220 is a relatively high-potential electrode.

That is, it may be that the first electrode 210 is the negative electrode with the second electrode 220 being the positive electrode.

The electrolyte and/or solvent composition(s), furthermore, may be different across the separator 400, or between the positive electrode compartment 610 and negative electrode compartment 620 sides.

The electrolyte and/or solvent composition(s) may be the same on both the positive electrode compartment 610 and negative electrode compartment 620 sides.

The redox flow battery 4000 according to Embodiment 3 further includes a second circulator 520.

The second circulator 520 is a mechanism that circulates the second nonaqueous liquid 120 between the second electrode 220 and the second active material 320.

The second circulator 520 includes a second container 521. The second circulator 520 includes piping 523, piping 524, and a pump 525. The pump 525 is, for example, provided on the piping 524. Alternatively, the pump 525 may be provided on the piping 523.

The second active material 320 and the second nonaqueous liquid 120 are contained in the second container 521.

The second active material 320 and the second nonaqueous liquid 120 come into contact with each other in the second container 521, and at least one of the following is carried out in consequence: the oxidation of the second electrode mediator 121 by the second active material 320 or the reduction of the second electrode mediator 121 by the second active material 320.

In this configuration, the second nonaqueous liquid 120 and the second active material 320 are brought into contact with each other in a second container 521. This helps, for example, increase the area of contact between the second nonaqueous liquid 120 and the second active material 320. The duration of contact between the second nonaqueous liquid 120 and the second active material 320 also becomes longer. As a result, at least one of the oxidation or reduction of the second electrode mediator 121 by the second active material 320 is carried out more efficiently.

In Embodiment 3, the second container 521 may be, for example, a tank.

The second container 521 may be, for example, filled with particles of the second active material 320, and the second nonaqueous liquid 120 may be held in the spaces between the particles of the second active material 320 with the second electrode mediator 121 dissolved therein.

One end of the piping 523 is connected to an outlet on the second container 521 for the second nonaqueous liquid 120 to flow out.

The other end of the piping 523 is connected to one of the positive electrode and negative electrode compartments 610 and 620, whichever the second electrode 220 is in. In FIG. 3, this end of the piping 523 is connected to the negative electrode compartment 620.

One end of the piping 524 is connected to one of the positive electrode and negative electrode compartments 610 and 620, whichever the second electrode 220 is in. In FIG. 3, this end of the piping 524 is connected to the negative electrode compartment 620.

The other end of the piping 524 is connected to an inlet on the second container 521 for the second nonaqueous liquid 120 to flow out.

The second circulator 520 in the redox flow battery 4000 according to Embodiment 3 may include a second filter 522.

The second filter 522 limits the penetration of the second active material 320.

The second filter 522 is provided in the channel through which the second nonaqueous liquid 120 flows out of the second container 521 toward the second electrode 220. In FIG. 3, the second filter 522 is on the piping 523. To be exact, the second filter 522 is at the joint between the second container 521 and the piping 523. Alternatively, the second filter 522 may be provided at the joint between the second container 521 and the piping 524. The second filter 522 may be at the joint between the electrochemical reaction section 600 and the piping 523 or at the joint between the electrochemical reaction section 600 and the piping 524.

In this configuration, the outflow of the second active material 320 somewhere other than the second container 521 is reduced. For example, the outflow of the second active material 320 toward the second electrode 220 is reduced. The second active material 320 stays in the second container 521 in consequence. By virtue of this, a redox flow battery is realized in which the second active material 320 itself is not allowed to circulate. The components of the second circulator 520 are therefore prevented from getting clogged inside with the second active material 320. For example, the piping in the second circulator 520 is prevented from getting clogged inside with the second active material 320. A loss due to resistance caused by the outflow of the second active material 320 toward the second electrode 220 becomes less frequent.

The second filter 522 filters out, for example, the second active material 320. The second filter 522 may be a component that has pores smaller than the smallest diameter of the particles of the second active material 320. The material for the second filter 522 can be one that does not react with the second active material 320, the second nonaqueous liquid 120, etc. The second filter 522 may be, for example, a piece of glass-fiber filter paper, a piece of polypropylene nonwoven fabric, a piece of polyethylene nonwoven fabric, or a piece of metal mesh that does not react with metallic lithium.

In this configuration, the second active material 320 is prevented from flowing out of the second container 521 even if the second active material 320 flows together with the second nonaqueous liquid 120 inside the second container 521.

In the example illustrated in FIG. 3, the second nonaqueous liquid 120 contained in the second container 521 is supplied to the negative electrode compartment 620 by passing through the second filter 522 and the piping 523.

The second electrode mediator 121, dissolved in the second nonaqueous liquid 120, is oxidized or reduced by the second electrode 220 in consequence.

Then the second nonaqueous liquid 120, with the oxidized or reduced second electrode mediator 121 dissolved therein, is supplied to the second container 521 by passing through the piping 524 and the pump 525.

As a result, the second electrode mediator 121, dissolved in the second nonaqueous liquid 120, is subjected to at least one of the following: the oxidation or reduction of the second electrode mediator 121 by the second active material 320.

The way to control the circulation of the second nonaqueous liquid 120 may be with the use of, for example, the pump 525. That is, the pump 525 is used to start and stop the supply of the second nonaqueous liquid 120 or to make adjustments, for example to the rate of supply of the second nonaqueous liquid 120, on an as-needed basis.

The way to control the circulation of the second nonaqueous liquid 120 does not need to be with the pump 525 and may be with another tool. Such a tool may be, for example, a valve.

It should be noted that in FIG. 3, the first electrode 210 is the positive electrode by way of example, with the second electrode 220 being the negative electrode.

The second electrode 220, however, can be the positive electrode if the first electrode 210 is a relatively low-potential electrode.

That is, it may be that the second electrode 220 is the positive electrode with the first electrode 210 being the negative electrode.

The configurations described in each of Embodiments 1 to 3 above may optionally be combined with one another.

### EXAMPLES

The following describes the present disclosure by providing examples. The present disclosure, however, is by no means limited to these examples. Many variations can be made by those ordinarily skilled in the art within the technical scope of the present disclosure.

### Preparation of a First Liquid

A lithium-biphenyl solution, in which biphenyl, an aromatic compound that can be used as a first electrode mediator, and metallic lithium were dissolved, was used as a first liquid (first nonaqueous liquid). This first liquid was prepared following the procedure described below.

First, biphenyl and LiPF₆, which is an electrolytic salt, were dissolved in triglyme, a first nonaqueous solvent. The concentration of biphenyl in the resulting solution was 0.1 mol/L. The concentration of LiPF₆ in the solution was 1 mol/L. To this solution, an excess of metallic lithium was added. The metallic lithium was dissolved until saturation, giving a deep-blue biphenyl solution saturated with lithium. The surplus metallic lithium remained as a precipitate. The supernatant of this biphenyl solution was therefore used as a first liquid. Then sizes of biphenyl solvated with triglyme were determined by density-functional theory ab initio computations with the basis set 6-31G. The size of biphenyl solvated with triglyme was larger than or equal to 4 nm and smaller than or equal to 14 nm. The size of aggregates containing two molecules of biphenyl solvated with triglyme was larger than or equal to 8 nm and smaller than or equal to 28 nm. The size of aggregates containing four molecules of biphenyl solvated with triglyme was larger than or equal to 16 nm and smaller than or equal to 56 nm.

### Preparation of a Second Liquid

Tetrathiafulvalene, which was a second electrode mediator, and LiPF₆, an electrolytic salt, were dissolved in triglyme, a second nonaqueous solvent. The resulting solution was used as a second liquid (second nonaqueous liquid). The concentration of tetrathiafulvalene in the second liquid was 5 mmol/L. The concentration of LiPF₆ in the second liquid was 1 mol/L. Then sizes of tetrathiafulvalene solvated with triglyme were determined by density-functional theory ab initio computations with the basis set 6-31G. The size of tetrathiafulvalene solvated with triglyme was larger than or equal to 4 nm and smaller than or equal to 15 nm. The size of aggregates containing two molecules of tetrathiafulvalene solvated with triglyme was larger than or equal to 8 nm and smaller than or equal to 30 nm. The size of aggregates containing four molecules of tetrathiafulvalene solvated with triglyme was larger than or equal to 16 nm and smaller than or equal to 60 nm.

### Construction of a Test System

The separator of Example 1, Example 2, or Comparative Example 1, described below, was set in an electrochemical cell. One milliliter each of the first and second liquids were put into the electrochemical cell, separated from each other by the separator. A first electrode was immersed in the first liquid, and a second electrode was immersed in the second liquid. The first and second electrodes were stainless steel foams. The open-circuit voltage was measured for 48 hours using an electrochemical analyzer.

### Example 1

The separator was a piece of porous silica glass (Akagawa Glass). The average diameter of pores in the porous glass used in Example 1 was 5 nm. The average diameter of pores in the porous glass was calculated according to the distribution of diameters of the pores obtained by measuring the adsorption isotherm by gas adsorption with nitrogen and converting the data by the BJH method. The porosity of the porous glass was 29%, and the thickness of the porous glass was 1 mm.

### Example 2

The separator was a piece of porous silica glass (Akagawa Glass). The average diameter of pores in the porous glass used in Example 2 was 15 nm. The average diameter of pores in the porous glass was calculated in the same way as in Example 1. The porosity of the porous glass was 30%, and the thickness of the porous glass was 1 mm.

### Comparative Example 1

The separator was a polyolefin three-layer separator, which is used in lithium-ion batteries. The average diameter of pores in the three-layer separator was 150 nm. The average diameter of pores in the three-layer separator was calculated in the same way as in Example 1. The thickness of the three-layer separator was 20 μm.

FIG. 4 is a graph representing the open-circuit voltage of the electrochemical cells of Example 1, Example 2, and Comparative Example 1. Table 1 presents the decrease in open-circuit voltage at 48 hours from baseline for the electrochemical cells of Example 1, Example 2, and Comparative Example 1.

TABLE 1

| | | | | | Comparative | |
|---|---|---|---|---|---|---|
| | Example 1 | | Example 2 | | Example 1 | |
| Separator | Porous silica | | Porous silica | | Polyolefin three- | |
| | glass | | glass | | layer separator | |
| Average diameter of | 5 | nm | 15 | nm | 150 | nm |
| pores in the separator | | | | | | |
| Initial open-circuit | 3.2 | V | 3.2 | V | 3.2 | V |
| voltage | | | | | | |
| Decrease in open-circuit | 6 | mV | 15 | mV | 1103 | mV |
| voltage at 48 hours | | | | | | |

The electrochemical cells of Examples 1 and 2 lost little of their open-circuit voltage within 48 hours, indicating that the crossover of mediators was mild in the electrochemical cells of Examples 1 and 2. The electrochemical cell of Comparative Example 1, by contrast, experienced a significant loss of open-circuit voltage, suggesting that the crossover of mediators occurred in the electrochemical cell of Comparative Example 1.

The redox flow battery according to an aspect of the present disclosure is suitable for use as, for example, a device or system for electricity storage.

What is claimed is:

1. A redox flow battery comprising:
a first nonaqueous liquid that contains a first nonaqueous solvent, a first electrode mediator, and metal ions;
a first electrode at least in part in contact with the first nonaqueous liquid;
a second nonaqueous liquid that contains a second nonaqueous solvent;
a second electrode that is a counter electrode with respect to the first electrode and is at least in part in contact with the second nonaqueous liquid; and
a separator that has a plurality of pores and separates the first and second nonaqueous liquids from each other, wherein
the plurality of pores have an average diameter larger than a size of each of the metal ions and smaller than a size of an aggregate containing molecules of the first electrode mediator solvated with the first nonaqueous solvent.

2. The redox flow battery according to claim 1, wherein the separator is made of porous glass.

3. The redox flow battery according to claim 1, wherein the average diameter of the plurality of pores is larger than or equal to 0.5 nm and is smaller than or equal to 15 nm.

4. The redox flow battery according to claim 3, wherein the average diameter of the plurality of pores is larger than or equal to 0.5 nm and is smaller than or equal to 5 nm.

5. The redox flow battery according to claim 1, wherein the metal ions include at least one selected from the group consisting of lithium ions, sodium ions, magnesium ions, and aluminum ions.

6. The redox flow battery according to claim 1, further comprising:
a first active material at least in part in contact with the first nonaqueous liquid; and
a first circulator configured to circulate the first nonaqueous liquid between the first electrode and the first active material, wherein:
the first electrode mediator is oxidized or reduced by the first electrode; and
the first electrode mediator is oxidized or reduced by the first active material.

7. The redox flow battery according to claim 1, further comprising a first active material at least in part in contact with the first nonaqueous liquid, wherein:
the first electrode mediator is an aromatic compound;
the metal ions are lithium ions;
the first nonaqueous liquid is capable of dissolving lithium;
the first active material is a substance having a property to store and release lithium;
the first nonaqueous liquid has an electrical potential of smaller than or equal to 0.5 V vs. Li⁺/Li; and
the separator is made of silica-based porous glass.

8. The redox flow battery according to claim 7, wherein the aromatic compound includes at least one selected from the group consisting of biphenyl, phenanthrene, trans-stilbene, cis-stilbene, triphenylene, o-terphenyl, m-terphenyl, p-terphenyl, anthracene, benzophenone, acetophenone, butyrophenone, valerophenone, acenaphthene, acenaphthylene, fluoranthene, and benzil.

9. The redox flow battery according to claim 1, further comprising a second active material at least in part in contact with the second nonaqueous liquid, wherein:
the second nonaqueous liquid contains a second electrode mediator;
the second electrode mediator is oxidized or reduced by the second electrode;
the second electrode mediator is oxidized or reduced by the second active material; and
the average diameter of the pores is smaller than smallest one of the size of the aggregate containing molecules of the first electrode mediator solvated with the first nonaqueous solvent and a size of an aggregate containing molecules of the second electrode mediator solvated with the second nonaqueous solvent.

10. The redox flow battery according to claim 9, wherein the second electrode mediator includes at least one selected from the group consisting of tetrathiafulvalene, triphenylamine, and derivatives thereof.

11. The redox flow battery according to claim 1, wherein the first and second nonaqueous solvents each independently contains a compound that has at least one selected from the group consisting of a carbonate group and an ether group.

12. The redox flow battery according to claim 11, wherein the first and second nonaqueous solvents each independently contains at least one selected from the group consisting of propylene carbonate, ethylene carbonate, dimethyl carbonate, ethyl methyl carbonate, and diethyl carbonate.

13. The redox flow battery according to claim 11, wherein the first and second nonaqueous solvents each independently contains at least one selected from the group consisting of dimethoxyethane, diethoxyethane, dibutoxyethane, diglyme, triglyme, tetraglyme, polyethylene glycol dialkyl ethers, tetrahydrofuran, 2-methyltetrahydrofuran, 2,5-dimethyltetrahydrofuran, 1,3-dioxolane, and 4-methyl-1,3-dioxolane.
